(19) United States
(12) Patent Application Publication
(10) Pub. No.: US 2008/0115465 A1
(43) Pub. Date: May 22, 2008

(54) CONTAINER MANAGEMENT SYSTEM

(75) Inventor: Kent H. Dickinson, Covington, GA (US)

Correspondence Address: Michael R. Henson & Associates, LLC, 5613 DTC Parkway, Suite 240, Greenwood Village, CO, 80111, US

(73) Assignee: Eggs Overnight, Inc., Stone Mountain, GA (US)

(21) Appl. No.: 11/941,366

(22) Filed: Nov. 16, 2007

Related U.S. Application Data
(63) Continuation-in-part of application No. 11/665,762.
(60) Provisional application No. 60/554,559, filed on Mar. 18, 2004.

(51) Int. Cl. B65B 7/16; B42D 15/00; B65D 25/54; B65B 43/26

(52) U.S. Cl. 53/476; 283/70; 206/769; 53/492

(57) ABSTRACT

Provided is a method for shipping a parcel from a primary to a secondary location in a reusable container, and returning the container to a tertiary location. The parcel is packaged in the container which includes a label construction. The label construction includes a base substrate for securing to the container, a sleeve overlaying the base substrate, and a transparent viewing window having an exposed surface for removably receiving an address label. A first removable label is adhered to the transparent viewing window and includes information corresponding to an address for the secondary location. A second removable label is placed inside the sleeve and includes information corresponding to an address for a tertiary location. The package is delivered to the secondary location where it is un-packed and the first label is removed thereby exposing the second label for viewing through the window for delivery to the tertiary location.

### BACKGROUND

A fundamental need of commerce-based societies is the transportation of goods from one location to another. The development of various postal systems, first on the national and then on an international basis, established an organized system wherein a carrier, for a price, would convey a parcel from a shipper to a recipient. The service provided by such carriers resulted in increasing demand and expansion of their served customer base. In addition to the governmentally sponsored postal services, private carriers have been organized to transport a wide variety of parcels for paying customers. Such companies include those known as United Parcel Service, Federal Express, DHL, Airborne and Emory, to name a few.

For the past 40-50 years, shippers have been conditioned to excessively package parcel shipments in order to protect their parcels from damage. Such excessive packaging leads to increased packing costs. This packaging cost can be attributed to various factors. First, parcels are typically packed inside a one-time use container, such as a paperboard carton, with the interior of the container filled with cushioning materials, such as Styrofoam “peanuts”, shredded paper or other paper-based filler, to name a few. Second, there is a substantial time investment in packaging that results from the need to carefully pack and seal the paperboard carton and prepare shipping documents. Third, when products are in need of protection, shippers over-package in containers that are very large, increasing the dimensional charge that carriers levy for lighter weight products that take up a lot of space. In many cases the actual product accounts for only about 25% of the available space inside each paperboard box. This is particularly the case when shipping high value, fragile products such as medical devices, electronics, and artwork to name a few. There is generally a large degree of over-packing and overweighting to make certain these products are ‘protected’ from damage. For example, the inventor is aware of at least one case where a company must on a regular basis ship an 87 lb. piece of equipment. In order to protect the equipment it is shipped in a wooden crate with a total shipping weight of 397 lbs. The current costs for the wood container and the heavy weight shipping is very high.

In order to address the economic disadvantages of one-time-use containers and over-packaging, reusable containers and methods have been developed which reduce the need for throwaway containers and over-packing. These containers and methods have lead to broad cost savings by reducing the need for cardboard boxes, bubble wrap, Styrofoam peanuts, and special molded plastic containers, for instance. Lightweight containers, such as described in my previous U.S. Pat. Nos. 6,737,974 and 7,106,202 and particularly my co-pending U.S. patent application Ser. No. 11/665,762 directed to a Shipping Container, provide significantly better product protection in dramatically lower weights and dimensions than with conventional packaging. For example, in the scenario above, shipping weight was reduced from 397 lbs to 118 lbs by employing these reusable containers. Lower total container weight, and/or smaller container dimension lowers the shipping rate. These containers are also reusable 20 to 50 times and in some cases as many as 100+ times. Package preparation is completed in 50-90% less time than traditional one-time-use disposable packaging.

While these containers have many economic advantages there are still factors that have limited the widespread adoption of reusable containers by some shippers, particularly small businesses. Although in the long run reusable containers make economic sense, many shippers object to the up-front cost associated with them. A reusable product costs more to manufacturer and, while the payback period can be relatively short, it may still require a sizeable capital investment.

Some shippers also object to the logistical overhead associated with reusable containers. For example, reusable containers must currently be inventoried for ready availability where cardboard boxes can be ordered on an as needed basis. Reusable containers should be periodically maintained or replaced whereas cardboard boxes are often just thrown away. The question shippers often have when considering reusable containers is “how are we going to keep track of all these boxes?” Tracking the location of each box and ensuring that they are returned in a timely fashion is an unknown that many shippers would rather just avoid.

In order to take full advantage of the benefits reusable shipping containers can offer there is a need for a better business model for their efficient and economical utilization. Reusable containers have high initial costs and logistical overhead when compared to one-time-use containers, costs that deter many potential customers. Accordingly there is a need for a method for using reusable containers that reduces or eliminates the initial cost to the shipper and frees the shipper from the logistical overhead of tracking and maintaining the containers. These are only some of the needs addressed by the present invention.

### SUMMARY

Provided is a method of shipping a parcel from a primary location to a secondary location with a reusable container whereby the container is returned to a tertiary location. While at the primary location a shipping package is created by placing a parcel into the reusable container. The shipping package includes a closable container body having an interior and a mouth communicating with the interior.

Also included, is a label construction which has a base substrate for securing to the container and a sleeve overlaying at least a portion of the base substrate. The sleeve has a sleeve opening for receiving an address label. The label also includes a transparent viewing window having an exposed surface for removably receiving an address label.

A first removable label is placed onto the transparent viewing window. The first removable label includes a strip constructed of a selected strip material and having a first surface region provided with information corresponding to an address for the secondary location. The first removable label also includes an opposed second surface region which has a selected adhesive for securing the label to the transparent viewing window during shipment to the secondary location. The adhesive is further selected to allow removal of the label from the transparent viewing window at the secondary location without tearing the strip material. A second removable label is placed inside the sleeve. The second removable label includes information corresponding to an address for a tertiary location.

Once the shipping package is complete the shipping package is delivered to the secondary location. At the secondary location the recipient unpacks the parcel from the reusable container and removes the first removable label to expose the second removable label for viewing through the window. The container is then delivered to the tertiary location.

It should be understood that the tertiary location may be the primary location. For example, a shipper located at a primary location may ship the package to a recipient at a secondary location who then returns the container to the shipper who is now designated as the tertiary location. Alternatively, the tertiary location could be a reusable container maintenance facility. In a case where the container is returned to a maintenance facility for service, the container may, thereafter, be returned to the primary location where the cycle starts again. The tertiary location may be chosen between the primary location and a maintenance facility or other location based on certain selected container metrics. Those metrics may include, for example, number of shipments logged on the container, shipping weight, and/or the particular customer.

The container management system may also include automatically charging the shipper a shipping fee for shipping the parcel. Preferably the shipping fee is charged shortly after the recipient receives the shipping package. Furthermore, the elapsed time between the receipt by the recipient of the shipping package and return of the reusable container to the tertiary location may be used to derive a service charge. Preferably, these fees are charged to the shipper via electronic data interchange (EDI), electronic funds transfer (EFT), or other suitable method as is known in the art.

### BRIEF DESCRIPTION OF THE FIGURES

FIG. 1 is a schematic representation of the major components of the container management system according to the exemplary embodiment;

FIG. 2 is a table illustrating a representative schedule for reminder notifications;

FIG. 3 is a perspective view illustrating a reusable container for use with the container management system;

FIG. 4 is an exploded perspective view of a reusable label construction for use on the reusable container of FIG. 3;

FIG. 5 is a diagrammatic representation of an exemplary shipping scenario;

FIG. 6 is a diagrammatic representation of a second exemplary shipping scenario;

FIG. 7 is a diagrammatic representation of a third exemplary shipping scenario;

FIG. 8 is a flow chart illustrating the logical steps involved in implementing shipping scenarios with the container management system;

FIG. 9 is a schematic diagram representing the overall relationship between the owner's facility, customer facility and receiver facility; and

FIG. 10 is a schematic representation of a representative computing environment for implementing one or more aspects of the teachings herein.

### DETAILED DESCRIPTION

Provided herein and described with reference to the various exemplary embodiments is a container management system for managing the life cycle of reusable containers such that shippers and recipients are relieved of the burden or tracking, maintaining, and inventorying reusable containers. These methods broadly entail bundling reusable containers with transportation and offering a per use, lump sum, price that may be below traditional packaging, shipping, and ancillary costs of damaged, lost, or stolen products.

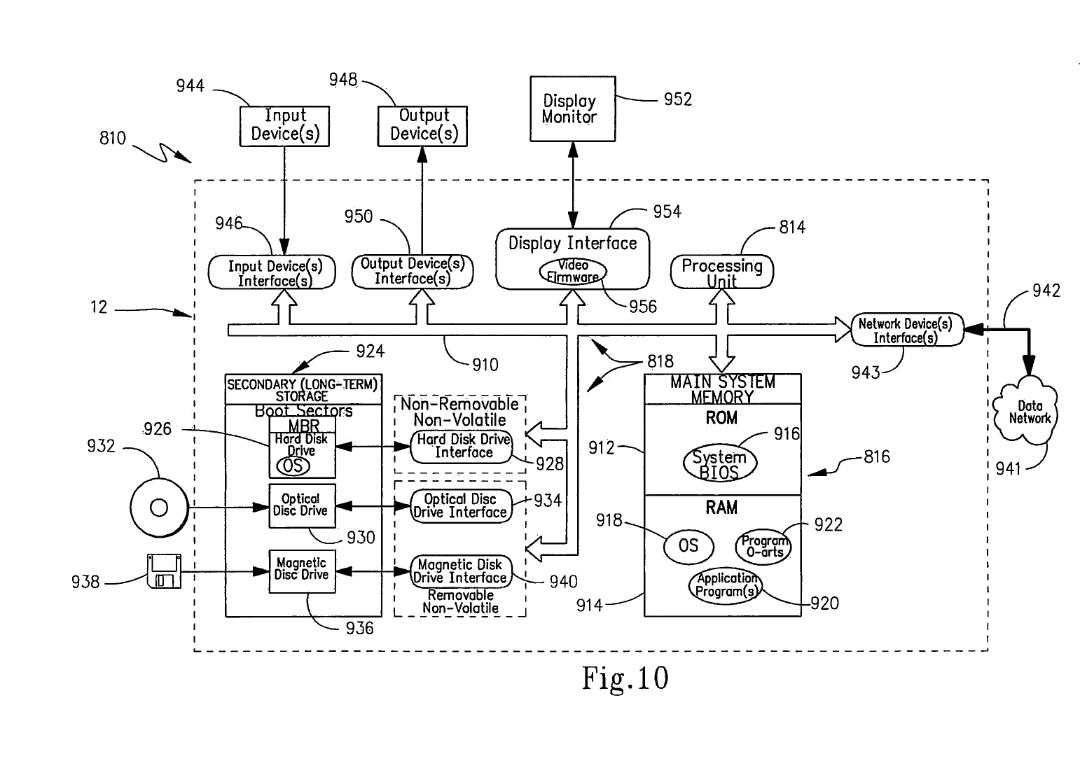

It should be understood that various computer environments and connections may be employed in the implementation of the present invention. With reference to FIG. 10, just such a representative computing environment is described. Computing environment 810 may utilize a general-purpose computer system 12 for executing applications in accordance with the described teachings. Computer system 12 may be adapted to execute in any of the well-known operating system environments, such as Windows, UNIX, MAC-OS, OS2, PC-DOS, DOS, etc. System 12 includes a processing unit 814 (e.g., a CPU) for executing instructions, a system memory 816 for storing programs and data currently in use by the system, and an input output (I/O) system, generally 818. These various components are interconnected by a system bus 910, which may be any of a variety of bus architectures. System memory 816 may include both non-volatile read only memory (ROM) 912 and volatile memory such as static or dynamic random access memory (RAM) 914. Programmable read only memories (PROMs), erasable programmable read only memories (EPROMs) or electrically erasable programmable read only memories (EEPROMs) may be provided. ROM portion 912 stores a basic input/output system (the system BIOS). RAM portion 914 stores an operating system (OS) 918, one or more application programs 920, as well as program data 922.

Various types of storage devices can be provided as more permanent data storage areas for the application programs and other data. These can be either read from or written to such as contemplated by secondary (long term) storage 924. Suitable devices may, for example, include a non-removable, non-volatile storage device in the form of a large-capacity hard disk drive 926 which is connected to the system bus 910 by a hard disk drive interface 928 such as ATA (IDE, EIDE), SCSI, FireWire/IEEE 1394, USB, or Fibre Channel. Hard disk drive 926 generally includes at least one bootable disk that stores the OS that is loaded into RAM 914 during a booting sequence, although the OS can alternatively be stored on removable media.

An optical disk drive 930 for use with a removable optical disk 932 such as a CD-ROM, DVD-ROM or other optical media, may also be provided and interfaced to system bus 910 by an associated optical disk drive interface 934. Computer system 12 may also have one or more magnetic disk drives 936 for receiving removable storage, such as a floppy disk or other magnetic media 938, which itself is connected to system bus 910 via magnetic disk drive interface 940. Remote storage over a network is also contemplated.

One or more of the memory or storage regions mentioned above may comprise suitable media for storing programming code, data structures, computer-readable instructions or other data types for the computer system 12. Such information is then utilized by processor 814 so that the computer system 12 can be configured to embody the capabilities described herein.

System 12 may be adapted to communicate with a data distribution network 941 (e.g., LAN, WAN, the Internet, etc.) via communication link(s) 942 so that, for instance, it can communicate with remote servers, clients, etc. Establishing network communications is aided by one or more network device interface(s) 943, such as a network interface card (NIC), a modem or the like suitably connected to the system bus 910. These can serve as a common interface for various other devices within a LAN and/or as an interface to allow networked computers to connect to external networks. System 12 preferably also operates with various input and output devices as part of I/O system 818. For example, user commands or other input data may be provided by any of a variety of known types of input devices 944 (e.g. keyboard, pointing device, game controller, power pad, digital camera, image scanner, modem, network card, touch screen, microphone, bar code reader) having associated input interface(s), generally 946. One or more output devices 948 (e.g. monitor or other suitable display device, printer, fax, recording device, plotter) with associated interfaces, generally 950, may also be provided. For instance, a display monitor 952 may be connected to the system bus 910 by a suitable display adapter 954 (i.e., video card) having associated video firmware 956.

Although certain aspects for a user's computer system may be preferred in the illustrative embodiments, the present invention should not be unduly limited as to the type of computers on which it can be implemented, and it should be readily understood that the teachings herein contemplate use in conjunction with any appropriate information processing device (IPD) having the capability of being configured in a manner for accommodating the teachings herein. Moreover, it should be recognized that these teachings could be adapted for use on computers other than general-purpose computers (e.g. embedded computers), as well as general-purpose computers without conventional operating systems.

Software embodying the present invention may be distributed in known manners, such as on computer-readable medium that contains the executable instructions for performing the methodologies discussed herein. Alternatively, the software may be distributed over an appropriate communications interface so that it can be installed on the user's computer system. Furthermore, alternate embodiments which implement the teachings in hardware, firmware or a combination of both hardware and firmware, as well as distributing the modules and/or the data in a different fashion will be apparent to those skilled in the art. It should, thus, be understood that the description to follow is intended to be illustrative and not restrictive, and that many other embodiments will be apparent to those of skill in the art upon reviewing the description.

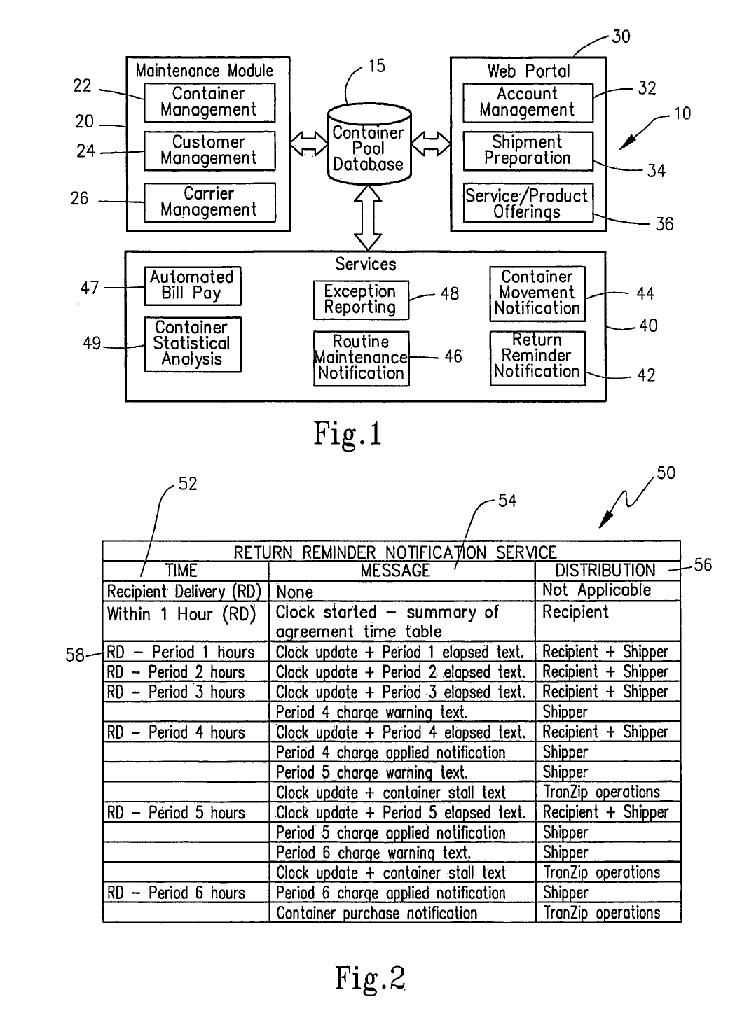

Central to the container management system is a database that may contain a collection of data files and application software that facilitate the management of a pool of reusable containers. The major components of the container management system are represented schematically in FIG. 1. The container management system 10 includes a container database 15, which is the central repository of all data required for the container management system. This database is scalable and constructed from commercially available components such as MS SQL server or Oracle. The composition of the data stored is best described by discussing the key data processing components, namely maintenance module 20, web portal module 30, and services module 40.

Maintenance module 20 consists of a manual data maintenance process for the initialization and maintenance of the container pool data. The maintenance module consists of software that allows for the manual input of data pertaining to the three primary data sets. Container management 22 is a set of data that is maintained for each container, such as unique serial number, product code, outside dimensions, inside dimensions, tare weight, and born on date. The customer management data set 24 includes data pertaining to each customer subscribed to the container management system. This data preferably includes customer name, service agreement, reference numbers, agreement period, agreement type, email contact information, and assigned container serial numbers. The carrier management data set 26 includes carrier information such as the carrier name, rates per zone and service level, additional charges, weight period, and volume discount schedule.

The web portal module 30 allows customers to have access to the container management system through a password protected customer account web portal. The web portal provides several applications as described below. The account management application 32 provides customers the ability to review their account, including charges. Customers can also manage their container pool (i.e. order additional containers, request container maintenance, and report container irregularities to name a few). Customers also have the ability to change their e-mail notification, contacts, and email notification logic (e.g., what type of notification for each contact).

The shipping preparation application 34 allows customers to use their own or carrier provided shipping preparation software. Preferably, customers will choose to use the shipping preparation application provided with the container management system. This application provides customers the ability to prepare ship-to and return shipping documents for local printing at their facility. Shipping data collected by this application is sent to the applicable carrier via electronic data interchange (EDI), as known in the art.

The service/product offerings application 36 is intended for use by container management system marketing personnel. Marketing personnel can use the analysis services to determine service and product offerings as well as indicators for applicable customer service goals. The service/product offerings application will monitor actual customer data and compare against these indicators to target offerings to customers.

Services module 40 consists of application software that executes automatically. The carrier movement notification application 44 notifies the container management system whenever a carrier picks up a container at a shipper's facility, for example. This notification is preferably through an e-mail system; however, it may also be through any suitable communication mode. The notification includes the pick up location, pick up time, service level, delivery location, and container serial number. Similarly, when the container is delivered to a recipient, an email notification, or other suitable communication, is sent to the container management system, which here includes the delivery location, delivery time, and container serial number. This process is repeated for the return trip from the receiver's facility back to the shipper's facility. As is described more fully below, the container may alternatively be shipped to a different facility such as a carrier hub facility or a maintenance facility. Regardless of the ship from location and receiver location, each complete roundtrip of the container in the system generates an e-mail notification at the time of shipment and time of receipt. These notifications are processed by the container movement notification application 44 by receiving, for instance, e-mail notifications and parsing the email for applicable data and creating a transaction record that is then stored in the container database.

The automated bill pay application 47 automatically handles billing the shipper for services rendered. In the preferred embodiments, payment for the container management service is due at the time the container is delivered to the recipient. Payment is due from the shipper in the amount agreed upon in the container management service agreement for that particular customer/shipper. The automatic bill pay application 47 preferably processes shipper payments via credit card or electronic funds transfer upon notification of the reusable container's delivery to the recipient.

The exception reporting application 48 is a group of background processes that constantly review certain key aspects of the container management system. For example, containers that reside in a shipper's non-transit inventory for an unacceptable duration, as is defined in the customer agreement, are flagged and reported. Other types of exceptions include missing or overdue containers, container bottlenecks, container shortfalls, payload weight out of specification for designated container, carrier service differential, etc. These background processes review the data, specifically container identifiers, to search for these types of exceptions and reports the exceptions based on severity and will include onscreen alarms to the maintenance modules. These reports can also be automated hardcopy reports, pager and mobile phone notifications, to name a few.

The container statistical analysis application 49 contains data, that when analyzed, provides important information for managing the container pool. The type of information reviewed by the container statistical analysis application 49 are the shipments per container, distance per shipment, service levels per container, minimum, maximum and average ship weight per container, shipments per period per shipper, revenue per period per shipper, carrier rate analysis, etc.

The routine maintenance notification application 46 notifies the shipper that a certain container should be returned to the maintenance facility for routine inspection and maintenance. This notification occurs after a certain number of shipments (as defined in the agreement) or at some other trigger such as payload weight out of specification for designated container or notification of atypical/special handling charges from the carrier. This service also selects containers at random for re-route to the maintenance facility for inspection and quality assurance tasks.

The return reminder notification application 42 helps ensure the efficient utilization of the container pool by sending reminder notifications when a container has sat idle for too long. The key performance metric of the container management system is the percentage of containers that are in transit at any given time. Optimum performance is therefore gained when this percentage is high. The return reminder notification application 42 is an automated process that constantly runs and starts an internal clock each time a container is delivered to a recipient facility. E-mail notifications are then generated and sent according to the schedule shown in FIG. 2.

FIG. 2 is a table illustrating a representative schedule 50 for sending reminder notifications. For each given time interval shown in the left most column 52 a particular message is sent to the shipper. For instance, in row 58 “Recipient Delivery (RD)+Period 1 hours” corresponds with message “clock update+Period 1 elapsed text.” The distribution of that message is shown in the right most column 56. In this case the text or message will be distributed to both the recipient and the shipper (“recipient+shipper”). For example, in row 58, once Period 1 has elapsed the Recipient and Shipper would both receive a message indicating the elapsed time (clock update) and a message indicating that Period 1 had elapsed (period 1 elapsed text). Period 1 could be any time period desired such as 12 hours. Period 1 elapsed text could be any suitable message such as “Your shipment was delivered and you have X hours to return the container before incurring additional charges.” It should be understood that these are exemplary time periods and messages only. The messages can be text messages, voicemail messages, e-mail, or the like.

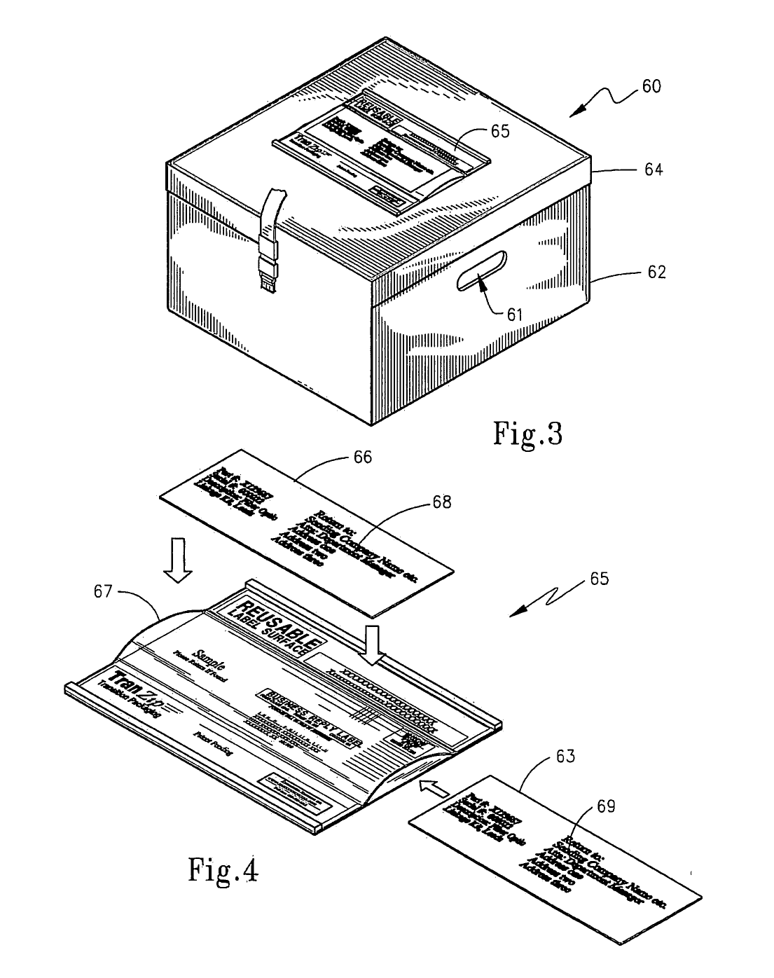

The container management system preferably employs reusable containers such as described in my co-pending U.S. patent application Ser. No. 11/665,762 the entire disclosure of which is hereby incorporated by reference. FIG. 3 illustrates a reusable container 60 with reusable label construction 65. Generally, reusable container 60 is constructed of an outer shell 62 constructed of corrugated material and an insert of foam, air, and or plastic film that is adhered together by glue or suitable other adhesives commonly used in the industry. The outer shell 62 is generally in a form of a box having a surrounding outer container wall that forms an interior. Formation of outer shell 62 is accomplished by means of a single, integral one-piece construction blank that is configured to be folded into a box. By way of example, the outer shell 62 may be constructed of 6-mil corrugated plastic while the insert is constructed of 10-mil plastic corrugated material. As shown, shipping container 60 includes lid 64 and may further be provided with handhold openings such as handhold opening 61.

Preferably the reusable label 65 is constructed such as disclosed in my previous U.S. Pat. No. 7,155,854, the entire disclosure of which is hereby incorporated herein by reference. With reference to FIG. 4, labeling construction 65 is adapted to receive a return address (or next leg) label 63 that may be removably inserted. Return address label 63 has indicia 69 corresponding to the shipper's return address and may also include other information, such as the container's unique identification number. Labeling construction 65 includes a sleeve 67, which is sized to receive the return address label 63 so that, once inserted, the return address label covers the address container's owner as illustrated. Sleeve 67 has at least one opening, which is sized to receive return address label 63. Once the label 63 is inserted, labeling construction resumes its flattened configuration to retain the label 32 in a compact, snug manner. Labeling construction 65 has at least the overlaying portion of its sleeve 67 formed of a transparent material to create a window for viewing return address label 63. Once the return address label 63 is inserted, a shipper applies a conventional outbound address label 66 to the exposed surface of sleeve 67, as shown in FIG. 4, wherein the outbound address label 66 is provided with indicia 68 corresponding to the recipient's address. Label 66 is formed as a strip of selected strip material provided with a suitable adhesive that is adapted to adhere to the sleeve's exposed surface. To this end, the exposed surface is coated with or formed from a release material, such as polytetrafluoroethylene or other suitable material, so that label 66 will adhere sufficiently to the window during transit, yet can be peeled away. Advantageously, this capability permits easy removal of conventional paper labels from the labeling constructions sleeve/window 67 without disrupting the ability to discern return address label 63 therethrough, thus allowing the container and its associated labeling construction to be reused numerous times.

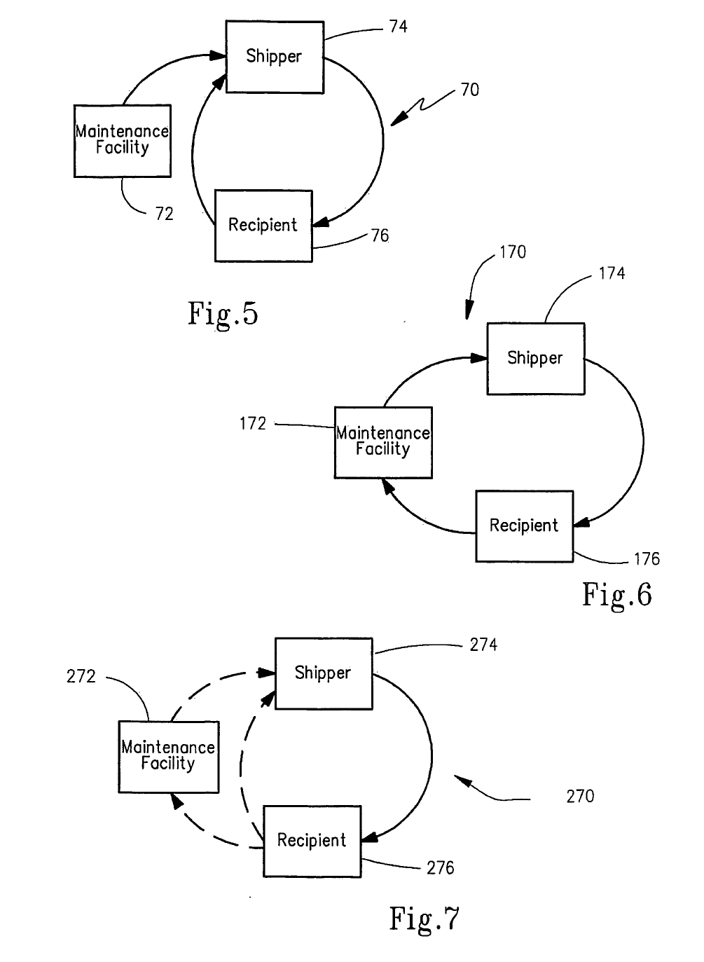

FIGS. 5, 6, and 7 are diagrammatic representations of three exemplary shipping scenarios that the container management system is designed to manage. It should be understood that these scenarios are merely examples and other scenarios may also be managed by the container management system and its variants. In general, the container is shipped between primary, secondary, and tertiary locations as explained more fully with the following scenarios.

FIG. 5 illustrates a relatively simple scenario 70 where, once the reusable container is delivered to shipper 74 from maintenance/inventory facility 72, the container cycles between the shipper 74 at a primary location and the recipient 76 at a secondary location. It should be understood that the shipper 74 becomes the tertiary location when the recipient 76 returns the container to the shipper.

FIG. 6 illustrates shipping scenario 170 where initially the reusable container is delivered from maintenance facility 172 to shipper 174. Shipper 174 can then create a shipping package by packaging the parcel to be shipped in a reusable container and attaching labels corresponding to the various legs of the container's route. Shipper 174 may then ship the package from the primary location via carrier to recipient 176 at the secondary location. Once the recipient receives the package and un-packages the parcel, the container is then forwarded back to the maintenance facility at a tertiary location where it can be maintained and/or replaced. This scenario might represent a one time shipping transaction where the container should be returned to the maintenance facility. Alternatively, this scenario is useful for parcels that have critical components that are easily damaged and the reusable container must be inspected before each use.

FIG. 7 illustrates a shipping scenario 270 where the container is again delivered from maintenance facility 272 to shipper 274 at a primary location for packaging and subsequently delivered to recipient 276 at a secondary location. In this case the container is shipped to a tertiary location, which is either the maintenance facility for maintenance or replacement or to the shipper for reuse. The decision as to whether the container should go from recipient 276 to maintenance facility 272 or shipper 274 depends on shipping container metrics such as payload weight out of specification, shipments per container, distance per shipment, minimum, maximum and average shipping weight, to name a few.

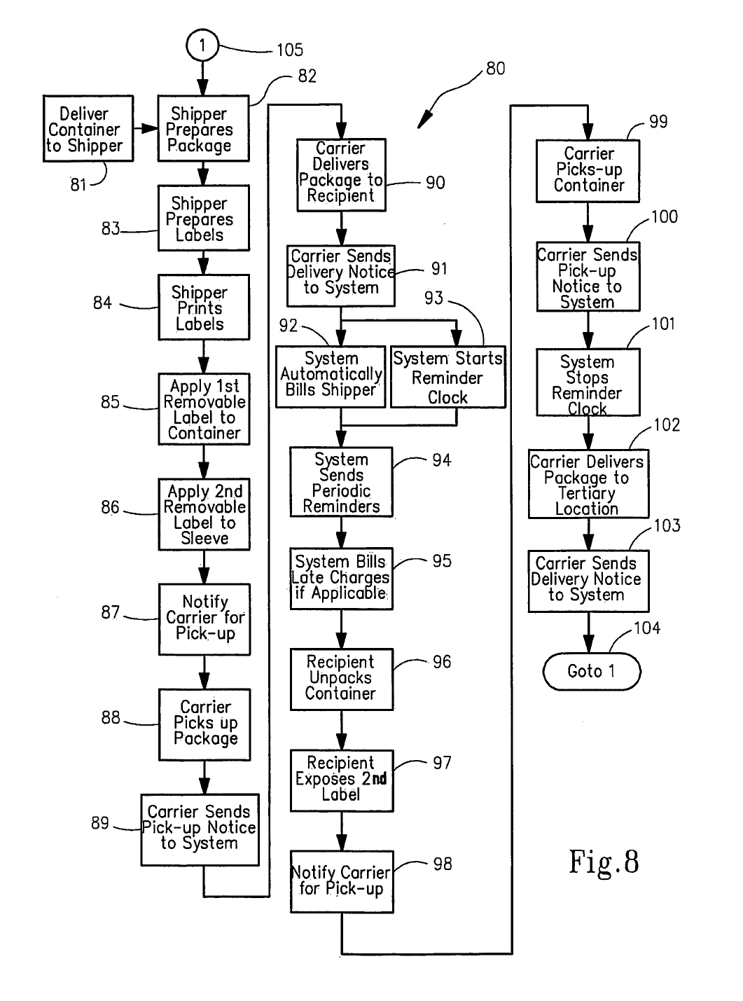

FIG. 8 is a flow chart illustrating the logical steps involved in implementing, for example, shipping scenario 70 as shown in FIG. 5. The reusable container is first delivered from maintenance facility 72 to the shipper 74 at step 81. Next, shipper 74 prepares the package for shipment at step 82. At step 83 the shipper prepares shipping labels that are applied to the container. In preparation for shipping, the shipper may use a numbered or color coded cable tie. The shipper prepares and prints the labels for the outbound and return ship legs and any intermediate ship leg. When preparing labels, the container's unique ID (license plate) is preferably entered during the label preparation process. The shipper will use the container owner's carrier designated billing number. Therefore, the container owner is billed for all shipping activity directly (third party billing). While preparing the labels at step 83, the shipper enters the container number either manually, via barcode reader, or via RFID. The shipper will prepare two or more labels—one label is for the outbound shipment from the shipper 74 at the primary location to recipient 76 at the secondary location (see FIG. 5), while the other is for the return leg (or next leg), which is the return of the reusable container from recipient 76 (secondary location) to shipper 74 which is now designated as the tertiary location. The shipper will then print the labels at step 84.

With reference to FIGS. 3 and 4, the first label for the outbound journey is applied to the label construction as described with respect to FIG. 4. At step 86 the shipper inserts the second label for the return journey in the label sleeve as again described in FIG. 4. Once the shipper has prepared the shipping package by inserting the parcel and closing the lid, as well as by printing labels and applying them to the container, the shipper will then notify the carrier for pick up at step 87. The carrier can be notified for pick up by telephone or online if the carrier is not routinely visiting the shipper's site on a daily basis. At step 88 the carrier picks up the package, and then at step 89 the carrier sends a pick up notice to the container management system. Preferably, the carrier notifies the system at step 89 via an e-mail notification, which is typical of many carriers' practices. This email would contain pertinent data which can be parsed by the container management system and thus begin the tracking process of the container. The carrier next delivers the package (step 90) to the recipient at the secondary location. Once the recipient has signed for the package at step 91 the carrier sends a delivery notice to the container management system. Again, preferably this notification is via e-mail with the pertinent data including time of delivery and signature. Once the carrier notifies the system that the package is delivered the system automatically bills the shipper at step 92.

Also, after the carrier notifies the system of delivery, the system will start a reminder clock in order to keep track of how long the container is out of service. At step 94 the system will send periodic reminders as necessary. These reminders can be via email, telephone, beeper, cell phone, etc. In addition, at step 95, if the container remains out for too long, which can be selectively determined by the user, the system will automatically bill late charges to the shipper. Once received the recipient will unpack the container at step 96 and then expose the second label for delivery on the return leg at step 97. At this point the recipient after having removed the contents of the package will notify the carrier to pick up the reusable container for return to the shipper at step 98. At step 99, the carrier picks up the container and again sends a notice to the container management system at 100. Also, at this point the system will stop the reminder clock and discontinue reminder messages as well the accrual of late fees. At step 102, the carrier delivers the container to the tertiary location, which in this example is the shipper. And finally, the carrier sends a delivery notice to the system at step 103. As in scenario 70 of FIG. 5, the process logically would flow back to step 105 to begin the process again.

This above flow represents an instantiation of the system. It should be understood, however, that the scenarios in FIGS. 6 and 7 could also be implemented with the same logical flow with the change in logic of returning the container not to the shipper but to the container owner's maintenance facility. It should also be understood that this is a representative scenario and that the logical flow of steps do not have to flow in exactly the same order. For example, at steps 85 and 86, one skilled in the art would recognize that inserting the second removable label into the sleeve could occur prior to applying the first removable label to the container. However, one skilled in the art would recognize that the shipper would most likely want to print the labels before applying them to the container.

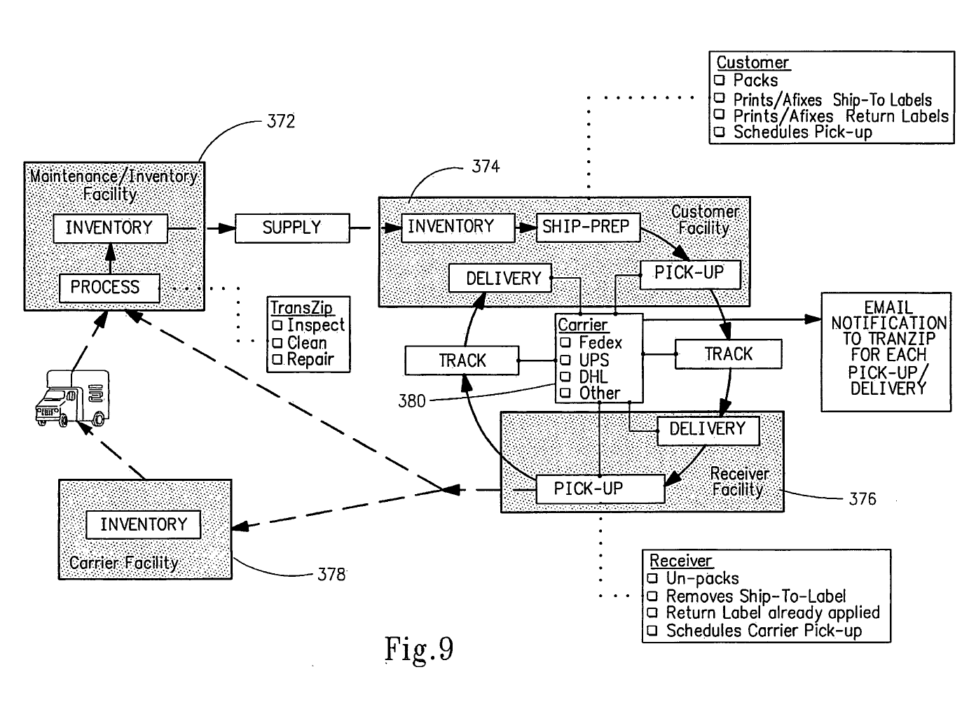

FIG. 9 is a diagram representing the overall relationship between the owner's maintenance facility, the shipper/customer, the carrier, and the recipient. This diagram illustrates the function of all three scenarios shown in FIGS. 5, 6, and 7. Beginning with the owner's maintenance/inventory facility 372, the reusable containers are stored at this facility until the customer/shipper has requirements for a particular reusable container. In addition to housing the reusable containers at the maintenance inventory facility, the owner carries out maintenance tasks such as inspection, cleaning, and repair. Facility 372 could also house the container management system; however, the container management system could be located at another location and connected via a data network. The shipper/customer's facility 374 would preferably house a small inventory of reusable containers, which would preferably be delivered on a just in time basis. As described above, the shipper would prepare the package including printing and applying the outbound and inbound labels. Also, the shipper and/or system would notify the carrier for pick up of the package. The carrier could be any of the regular carriers such as FedEx, UPS, and DHL, to name a few. As illustrated in the diagram, the carrier would notify the container management system at each step of the shipping process. For instance, at pick up, tracking, and once the package is delivered to the recipient 376. Once recipient 376 unpacks the package and removes the ship-to label thereby revealing the return label, the container is then picked up for delivery by the carrier and delivered either to the customer/shipper facility 374, return hub 378, or the maintenance/inventory facility 372. The determination of which location the container is returned to is determined by the system or the customer 374 prior to shipping. Thus, the printed labels would already have the correct return address. Hub return 378 is located at the carrier facility and acts as an inventory for the reusable containers to be stored until a sufficient quantity of containers accumulates thereby economically justifying the return of all of the containers at once. The return of the containers to the owner's maintenance inventory facility 372 could be either shipped via the carrier or the owner may pick up the containers using their own transportation.

Accordingly, the present invention has been described with some degree of particularity directed to certain exemplary embodiments of the present invention. It should be appreciated, though, that the present invention is defined by the following claims construed in light of the prior art so that modifications or changes may be made to the preferred embodiment of the present invention without departing from the inventive concepts contained herein.

I claim:

1. A method of shipping a parcel from a primary location to a secondary location with a reusable container, whereby said container is returned to a tertiary location, comprising:
a) at the primary location and in any order:
i) creating a shipping package by packaging the parcel to be shipped in a reusable container that includes:
1) a closable container body having an interior and a mouth communicating with the interior;
2) a label construction including:
a) a base substrate for securing to the container,
b) a sleeve overlaying at least a portion of said base substrate, said sleeve having a sleeve opening for receiving an address label, and
c) a transparent viewing window having an exposed surface for removably receiving an address label;
ii. placing a first removable label onto the transparent viewing window, said first removable label including:
1) a strip constructed of a selected strip material and having a first surface region provided with information corresponding to an address for the secondary location, and
2) an opposed second surface region provided with a layer of a selected adhesive so that the opposed second surface region of said label can be secured to said transparent viewing window during shipment to the secondary location, yet removed therefrom at the secondary location without tearing the strip of material;
iii. placing a second removable label inside said sleeve,
said second removable label including information corresponding to an address for a tertiary location;
b) delivering the shipping package to the secondary location;
c) at the secondary location and in any order:
i) un-packaging the parcel from the reusable container;
ii) removing said first removable label, thereby exposing said second removable label for viewing through said window; and
d) delivering the container to the tertiary location.

2. The method according to claim 1 wherein said tertiary location is the primary location.

3. The method according to claim 1 wherein said tertiary location includes a reusable container maintenance facility.

4. The method according to claim 3 including returning said container to the primary location.

5. The method according to claim 1 wherein said tertiary location is selected from the primary location and a location including a reusable container maintenance facility based on selected container metrics.

6. The method according to claim 5 wherein said selected container metrics are chosen from the group consisting of number of shipments, shipping weight, and customer.

7. A method of shipping a parcel in a reusable container from a shipper located at a primary location to a recipient located at a secondary location, whereby said container is returned to a tertiary location, comprising:
a) at the primary location and in any order:
i) creating a shipping package by packaging the parcel to be shipped in a reusable container that includes:
1) a closable container body having an interior and a mouth communicating with the interior;
2) a unique identifier indicia; and
3) a label construction including:
a) a base substrate for securing to the container,
b) a sleeve overlaying at least a portion of said base substrate, said sleeve having a sleeve opening for receiving an address label, and
c) a transparent viewing window having an exposed surface for removably receiving an address label;
ii. placing a first removable label onto the transparent viewing window, said first removable label including:
1) a strip constructed of a selected strip material and having a first surface region provided with information corresponding to an address for the secondary location, and
2) an opposed second surface region provided with a layer of a selected adhesive so that the opposed second surface region of said label can be secured to said transparent viewing window during shipment to the secondary location, yet removed therefrom at the secondary location without tearing the strip of material;
iii. placing a second removable label inside said sleeve, said second removable label including information corresponding to an address for a tertiary location;
b) delivering the shipping package to the secondary location for receipt by the recipient;
c) at the secondary location and in any order:
i) un-packaging the parcel from the reusable container;
ii) removing said first removable label, thereby exposing said second removable label for viewing through said window;
d) scheduling delivery of reusable container to the tertiary location;
e) recording elapsed time between receipt by the recipient and scheduling delivery of reusable container to the tertiary location; and
f) delivering the container to the tertiary location.

8. The method according to claim 7 including determining a late fee based on said elapsed time and charging said shipper.

9. The method according to claim 8 including charging said shipper a shipping fee for shipping said parcel.

10. The method according to claim 9 wherein said shipping fee is charged after said receipt by the recipient.

11. The method according to claim 10 wherein said shipping and said late fee are charged via electronic data interchange (EDI).
